(19) United States
(12) Patent Application Publication
(10) Pub. No.: US 2009/0310581 A1
(43) Pub. Date: Dec. 17, 2009

(54) HRPD/3GPP EPC network connection apparatus, system, and method

(75) Inventors: Atte Lansisalmi, Atlanta, GA (US); Basavaraj Patil, Coppell, TX (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 12/457,482

(22) Filed: Jun. 12, 2009

Related U.S. Application Data
(60) Provisional application No. 61/129,261, filed on Jun. 13, 2008.

(51) Int. Cl. H04W 76/00

(52) U.S. Cl. 370/338; 370/401

(57) ABSTRACT

An apparatus, system, and method may include a user device, an HRPD network comprising a HSGW, and a 3GPP EPC network comprising at least one gateway. The user device may be configured to detect a need to establish a connection with the 3GPP EPC network, determine an APN value that corresponds to the 3GPP EPC network, include the APN value in a connection request, and communicate the connection request to an HRPD gateway of the HRPD network. The HRPD gateway may be configured to receive the connection request from the user device, determine a PDN gateway of the 3GPP EPC network that corresponds to the APN value in the connection request, and enable a connection between the user device and the 3GPP EPC network.

This application claims priority of U.S. Provisional Patent Application No. 61/129,261, filed on Jun. 13, 2008. The subject matter of this earlier application is hereby incorporated by reference.

### BACKGROUND

1. Technical Field

The present invention relates generally to communication systems. More specifically, the present invention relates to apparatuses, systems, and methods for enabling connections between a High Rate Packet Data (HRPD) network and a 3^{rd} Generation Partnership Project (3GPP) Evolved Packet Core (EPC) network.

2. Description of the Related Art

The 3rd Generation Partnership Project 2 (3GPP2) is a collaboration between telecommunications associations to make a globally applicable third generation mobile phone system specification within the scope of the International Telecommunication Union's (ITU) International Mobile Telecommunciations-2000 (IMT-2000) project. In practice, 3GPP2 is the standardization group for code division multiple access (CDMA) 2000, which is a set of third generation standards based on earlier second generation CDMA technology. 3GPP2 standardization encompasses a High Rate Packet Data (HRPD) network.

Similarly, the 3rd Generation Partnership Project (3GPP) is a collaboration between groups of telecommunications association, to make a globally applicable next generation mobile phone system specification within the scope of the IMT-2000 project of the ITU. However, 3GPP specifications are based on evolved Global System for Mobile Communications (GSM) specifications. 3GPP standardization encompasses System Architecture Evolution (SAE), being synonymous to Evolved Packet Core (EPC) Networks.

The HRPD network of a 3GPP2 system provides increased communication performance by, for example, increasing data transmission speeds. The EPC of a 3GPP system provides mobility management, session management, and transport for Internet Protocol (IP) packet services. Though the HRPD of 3GPP2 and the EPC of 3GPP independently provide functionality, no complete solution exists yet for enabling a user device in an HRPD network of a 3GPP2 system to establish a connection with the EPC network of a 3GPP system.

### SUMMARY

The present invention has been developed in response to the present state of the art, and in particular, in response to the problems and needs in the art that have not yet been fully solved by currently available communication system technologies. Accordingly, embodiments of the present invention can enable a user device in a High Rate Packet Data (HRPD) network of a 3^{rd} Generation Partnership Project 2 (3GPP2) system to establish a connection with an Evolved Packet Core (EPC) of a 3^{rd} Generation Partnership Project (3GPP) system.

In some embodiments of the present invention, a method may include detecting a need to establish a connection with a 3^{rd} Generation Partnership Project (3GPP) Evolved Packet Core (EPC) network, determining an Access Point Name (APN) value that corresponds to the 3GPP EPC network, including the APN value in a connection request message, and communicating the connection request to a High Rate Packet Data (HRPD) network to establish a connection with the 3GPP EPC network.

In certain embodiments, the detecting, the determining, the including, and the communicating correspond to a network entry procedure. In some embodiments, the detecting of the need to establish a connection with a packet data network is based on selected criteria. In certain embodiments, the criteria include an operator ID in a broadcast message. In other embodiments, the criteria include acknowledgment of a capacity of the HRPD network and/or the 3GPP EPC network.

In some embodiments, the communicating includes communicating the connection request message to a High Rate Packet Data Serving Gateway (HSGW) of the HRPD network. The HSGW may include a Proxy Mobile IPv6 (PMIP6) Mobile Access Gateway (MAG) function for determining an appropriate PDN gateway for sending a Proxy Binding Update (PBU) message. In some embodiments, the connection established may correspond to a PDN gateway having a Local Mobility Anchor (LMA) function and corresponding to the 3GPP EPC network. In certain embodiments, the connection includes a Generic Routing Encapsulation (GRE) tunnel. In some embodiments, the detecting, the determining, the including, and the communicating are performed by a user device.

In some embodiments of the present invention, an apparatus may include a connection detection unit configured to detect a need to establish a connection with a 3GPP EPC network, an APN determination unit configured to determine an APN value that corresponds to the 3GPP EPC network, a connection request generation unit configured to include the APN value in a connection request message, and an HRDP interface unit configured to communicate the connection request to an HRPD network to establish a connection with the 3GPP EPC network.

In certain embodiments, the connection detection unit, the APN determination unit, the connection request generation unit, and the HRPD interface unit are each configured to operate according to a network entry procedure. In certain embodiments, the connection detection unit is configured to detect the need to establish a connection based on selected criteria such as an operator identity in a broadcast message or the capacity of the HRPD network and/or 3GPP EPC network.

In some embodiments, the HRPD interface unit is configured to communicate the connection request to an HSGW of the HRPD network. In certain embodiments, the HSGW includes a PMIP6 MAG function for determining an appropriate PDN gateway of the 3GPP EPC network for sending a PBU message. In certain embodiments, the PDN gateway includes a LMA function configured to facilitate establishment of the connection. Depending on the embodiment, the connection may include a GRE tunnel.

In some embodiments of the present invention, an apparatus may include a detecting means for detecting a need to establish a connection with a 3GPP EPC network, a determining means for determining an APN value that corresponds to the 3GPP EPC network, an including means for including the APN value in a connection request, and a communicating means for communicating the connection request to an HRPD network to establish a connection the 3GPP EPC network.

In some embodiments of the present invention, a computer program is embodied on a computer-readable medium. The computer program may be configured to control a processor to perform operations including detecting a need to establish a connection with a 3GPP EPC network, determining an APN value that corresponds to the 3GPP EPC network, including the APN value in a connection request message, and communicating the connection request to an HRPD network to establish a connection with the 3GPP EPC network.

In some embodiments of the present invention, a method may include receiving, by an HRPD gateway of an HRPD network, a connection request from a user device, wherein the connection request includes an APN value, determining a PDN gateway that corresponds to the APN value in the connection request, and enabling a connection between the user device and 3GPP EPC network corresponding to the PDN gateway.

In certain embodiments, determining the PDN gateway that corresponds to the APN value includes using a Proxy Mobile IPv6 (PMIP6) Mobile Access Gateway (MAG) function. In some embodiments, the enabling of the connection includes sending a Proxy Binding Update (PBU) message to the PDN gateway. In certain embodiments, the enabling of the connection includes enabling a Generic Routing Encapsulation (GRE) tunnel.

In some embodiments of the present invention, an apparatus may include a connection request reception unit configured to receive, in an HRPD gateway of an HRPD network, a connection request from a user device. The connection request may include an APN value. The apparatus may also include a PDN gateway determination unit configured to determine a PDN gateway that corresponds to the APN value in the connection request, and a connection enabling unit configured to enable a connection between the user device and a 3GPP EPC network corresponding to the PDN gateway.

In certain embodiments, the PDN gateway determination unit is configured to use a PMIP6 MAG function. In some embodiments, the connection enabling unit is configured to send a PBU message to the PDN gateway. In certain embodiments, the connection enabling unit is configured to enable a GRE tunnel.

In some embodiments of the present invention, an apparatus includes a means for receiving, by a network node of an HRPD network, a connection request from a user device, wherein the connection request includes an APN value, a means for determining a PDN gateway that corresponds to the APN value in the connection request, and a means for enabling a connection between the user device and a 3GPP EPC network corresponding to the PDN gateway.

In some embodiments of the present invention, a computer program is embodied on a computer-readable medium. The computer program may be configured to control a processor to perform operations including receiving, by an HRPD gateway of an HRPD network, a connection request from a user device, wherein the connection request includes an APN value, determining a PDN gateway that corresponds to the APN value in the connection request, and enabling a connection between the user device and 3GPP EPC network corresponding to the PDN gateway.

In some embodiments of the present invention, a system includes a user device, an HRPD network that includes a HSGW, and a 3GPP EPC network that includes at least one PDN gateway. The user device may be configured to detect a need to establish a connection with the 3GPP EPC network, determine an APN value that corresponds to the 3GPP EPC network, include the APN value in a connection request, and communicate the connection request to an HRPD gateway of the HRPD network. The HRPD gateway may be configured to receive the connection request from the user device, determine a PDN gateway of the 3GPP EPC network that corresponds to the APN value in the connection request, and enable a connection between the user device and the 3GPP EPC network.

### BRIEF DESCRIPTION OF THE DRAWINGS

A more particular description of some of the embodiments of the present invention briefly described above will be rendered by reference to specific embodiments that are illustrated in the appended drawings. While it should be understood that these drawings depict only some embodiments of the invention and are not therefore to be considered to be limiting of its scope, the invention will be described and explained with additional specificity and detail through the use of the accompanying drawings, in which:

FIG. 1 is a block diagram of an HRPD/EPC connection system in accordance with one embodiment of the present invention;

FIG. 2 is a block diagram of a user device in accordance with one embodiment of the present invention;

FIG. 3 is a block diagram of an HRPD serving gateway in accordance with one embodiment of the present invention;

FIG. 4 is a flow chart diagram of an HRPD/EPC connection method in accordance with one embodiment of the present invention;

FIG. 5 is a flow chart diagram of an HRPD/EPC connection method in accordance with one embodiment of the present invention; and

FIG. 6 is a block diagram of a system in accordance with one embodiment of the present invention.

### DETAILED DESCRIPTION

It will be readily understood that the components of the present invention, as generally described and illustrated in the figures herein, may be arranged and designed in a wide variety of different configurations. Thus, the following more detailed description of the embodiments of apparatuses, systems, and methods of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

In addition, while the terms, data, packet, and/or datagram may be used in this specification, embodiments of the present invention may be applied to many types of network data. The term “data” may include packet, cell, frame, datagram, bridge protocol data unit packet, packet data and any equivalents thereof.

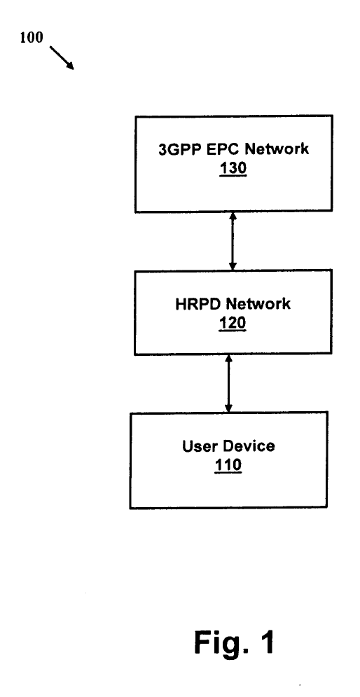

FIG. 1 is a block diagram of one embodiment of an HRPD/EPC connection system 100 in accordance with the present invention. The depicted system 100 includes a user device 110, a High Rate Packet Data (HRPD) network 120, and a 3^{rd} Generation Partnership Project (3GPP) Evolved Packet Core (EPC) network 130. The features of the system 100 cooperate to enable a connection between the user device 110 and the 3GPP EPC network 130 via the HRPD network 120.

In certain embodiments, the user device 110 is configured to detect a need to establish a connection with the 3GPP EPC network 130 and determine an Access Point Name (APN) value that corresponds to the 3GPP EPC network 130. In some embodiments, the user device 110 may also include the APN value in a connection request message and communicate the connection request message to the HRPD network 120.

In some embodiments, the HRPD network 120 may receive the connection request message and determine a PDN gateway of the 3GPP EPC network 130 that corresponds to the APN value in the connection request message. Upon determining the PDN gateway, the HRPD may operate to enable a connection between the user device and the PDN gateway. In this manner, the present invention enables a user device 110 to establish a connection with the 3GPP EPC network 130 via the HRPD 120 network.

One skilled in the art will appreciate that the system 100 depicted in FIG. 1, as well as the content provided throughout this specification, may be implemented according to 3GPP and 3GPP2 technology. Naturally, therefore, the specifications of 3GPP and 3GPP2 are incorporated herein by reference.

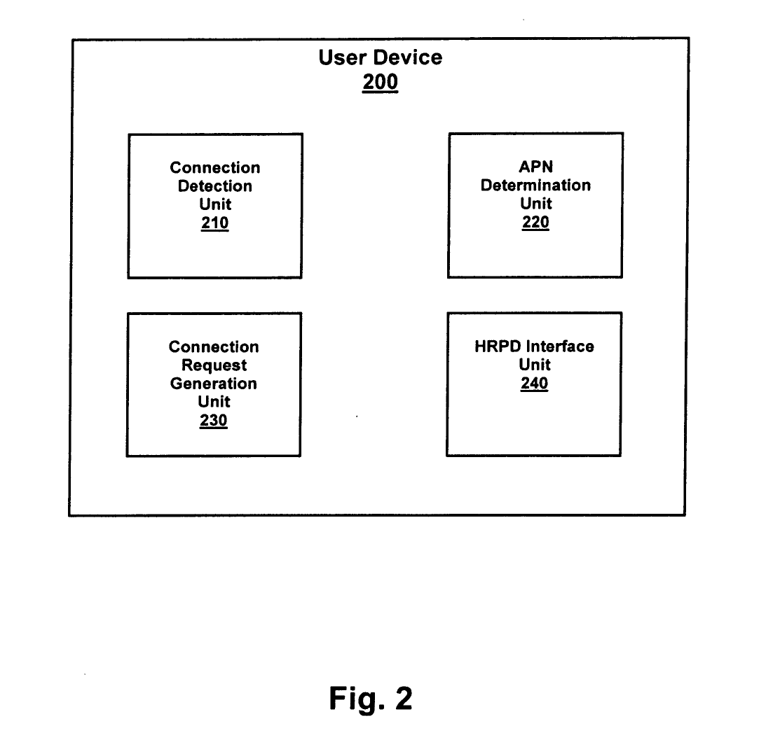

FIG. 2 is a block diagram of a user device 200 in accordance with one embodiment of the present invention. The depicted user device 200 includes a connection detection unit 210, an APN determination unit 220, a connection request generation unit 230, and an HRPD unit 240. The components of the user device 220 cooperate to enable a connection between the user device 200 and a 3GPP EPC network (not shown) via an HRPD network (also not shown). In some embodiments, the user device 200 corresponds to the user device 110 of FIG. 1.

In certain embodiments, the connection detection unit 210 is configured to detect a need to establish a connection with a 3GPP EPC network. In some embodiments, the connection detection unit 210 may use selected criteria, such as an operator identity or a capacity of the 3GPP EPC network, to detect a need to establish the connection. In some embodiments, the APN determination unit 220 may be configured to determine an APN value that corresponds to the 3GPP EPC network.

In certain embodiments, the connection request generation unit 230 may be configured to include the APN value in a connection request message, and the HRPD interface unit 240 may be configured to communicate the connection request message to a High Rate Packet Data Serving Gateway (HSGW) of an HRPD network to establish a connection with a PDN gateway that corresponds to the 3GPP EPC network. The connection request may comprise a request corresponding to a PDN connection request or a request for configuration according to a specified protocol such as a Vendor Specific Network Control Protocol (VSNCP) Configuration Request. In some embodiments, some or all of operations described above may be performed as part of a network entry procedure. In certain embodiments, the resulting connection between the user device 200 and the 3GPP EPC network may include a tunnel connection, such as a Generic Routing Encapsulation (GRE) tunnel.

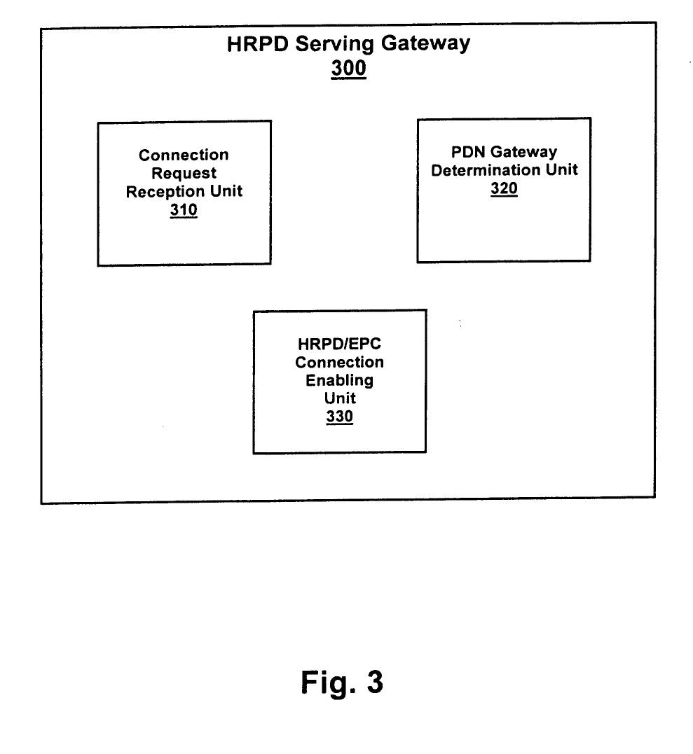

FIG. 3 is a block diagram of an HRPD serving gateway 300 in accordance with one embodiment of the present invention. The depicted HRPD serving gateway 300 includes a connection request reception unit 310, a PDN gateway determination unit 320, and an HRPD/PDN connection enabling unit 330. The components of the HRPD serving gateway 300 operate to enable a connection between a user device (not shown) and a 3GPP EPC network (also not shown). In some embodiments, the HRPD serving gateway 300 corresponds to the HRPD network 120 of FIG. 1.

In some embodiments, the connection request reception unit 310 is configured to receive a connection request from a user device. The connection request may include an APN that corresponds to a 3GPP EPC network. The PDN gateway determination unit 320 may be configured to determine a PDN gateway that corresponds to the APN value in the connection request. In some embodiments, the PDN gateway determination unit 320 may be configured to perform a Proxy Mobile IPv6 (PMIP6) Mobile Access Gateway (MAG) function to determine an appropriate PDN gateway (or the local mobile anchor function therein) to send a proxy binding update message. In certain embodiments, the HRPD/PDN connection enabling unit 330 may be configured to enable a connection between the user device and the PDN gateway.

In certain embodiments, the 3GPP EPC network 130 includes a Mobile Management Entity (MME) and/or a serving gateway (S-GW) that use the APN information to determine the PDN gateway to which the connection is to be established, and, based on the APN information, IPv6 or GTP technology may facilitate establishment of a connection/bearer/tunnel to the appropriate PDN gateway. Accordingly, the components of the HRPD gateway can be configured to enable a connection between a user device and a 3GPP EPC network.

In certain embodiments, the PDN gateway is configured to provide connectivity with multiple PDNs (i.e., 3GPP EPC networks/Evolved Universal Terrestrial Radio Access Network (E-UTRAN)). In such an embodiment, if a user device requests connectivity to multiple PDNs, the user device may indicate the APN value for each PDN in separate PDN connection request messages, and a separate GRE tunnel using GRE keys for each PDN may be established between a HSGW and a PDN gateway. In some embodiments, the user device may require connectivity to different PDN gateways that serve the same PDN. In such embodiments, the HSGW may send a PBU with the APN as a separate transaction.

It should be noted that many of the functional features described in this specification have been presented as units, in order to more particularly emphasize their implementation independence. For example, a unit may be implemented as a hardware circuit comprising custom VLSI circuits or gate arrays, off-the-shelf semiconductors such as logic chips, transistors, or other discrete components. A unit may also be implemented in programmable hardware devices such as field programmable gate arrays, programmable array logic, programmable logic devices or the like.

Units may also be partially implemented in software for execution by various types of processors. An identified unit of executable code may, for instance, comprise one or more physical or logical blocks of computer instructions which may, for instance, be organized as an object, procedure, or function. Nevertheless, the executables of an identified unit need not be physically located together, but may comprise disparate instructions stored in different locations which, when joined logically together, comprise the unit and achieve the stated purpose for the unit.

Indeed, a unit of executable code could be a single instruction, or many instructions, and may even be distributed over several different code segments, among different programs, and across several memory devices. Similarly, operational data may be identified and illustrated herein within units, and may be embodied in any suitable form and organized within any suitable type of data structure. The operational data may be collected as a single data set, or may be distributed over different locations including over different storage devices, and may exist, at least partially, merely as electronic signals on a system or network.

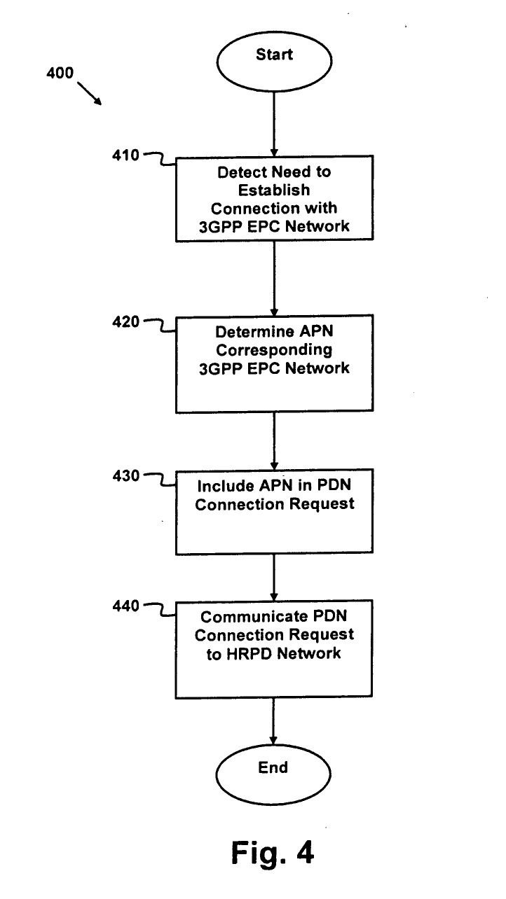

FIG. 4 is a flow chart diagram of an HRPD/EPC connection method 400 in accordance with the present invention. The method 400 includes detecting 410 a need to establish a connection with a 3GPP EPC network, determining 420 an APN corresponding to the 3GPP EPC network, including 430 the APN in a connection request, and communicating 440 the connection request to an HSGW. In certain embodiments, the operations of the method 400 may correspond to operations performed by the user device 110 of FIG. 1 or the user device 200 of FIG. 2. In some embodiments, the operations of the method 400 can enable a connection between a user device and a 3GPP EPC network via an HRPD network.

In some embodiments, detecting 410 a need to establish a connection with a 3GPP EPC network may include a variety of scenarios. For example, the detecting 410 may result from a command or condition internal to a user device, or a command or condition that is external to a user device. Accordingly, one skilled in the art will appreciate that the scenarios triggering the detecting 410 may be many.

In certain embodiments, determining 420 an APN corresponding to the 3GPP EPC network may include a user device accessing a repository of data to correlate the detected need with one or more 3GPP EPC networks. This repository may be stored internal or external of the user device, and accessing the data may include internal and/or external operations. For example, the user device may access a local data storage for the information or communicate with another network device to obtain access to the information. In some embodiments, the determining 420 may also include choosing an appropriate 3GPP EPC network amongst a plurality of possible 3GPP EPC networks.

In some embodiments, including 430 the APN in a connection request may include a user device preparing a PDN Connection Request message of the 3GPP2 specification that includes an APN of a 3GPP EPC network. In some embodiments, communicating 440 the connection request to an HSGW may include a user device sending, via an HRPD interface, to a gateway of an HRPD network to which the user device is connected. As described elsewhere in this specification, the HSGW may use the PDN connection to enable a connection between the user device and the 3GPP EPC network. Accordingly, the operations of the method may be performed to enable a connection between a user device and a 3GPP EPC network via an HRPD network.

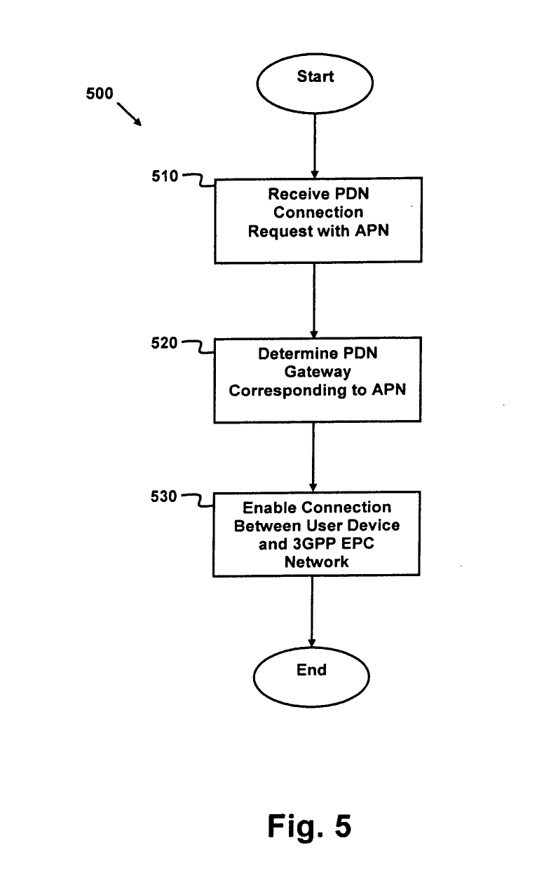

FIG. 5 is a flow chart diagram of one embodiment of an HRPD/EPC connection method 500 in accordance with the present invention. The depicted method 500 includes receiving 510 a connection request with an APN, determining 520 a PDN gateway corresponding to the APN, and enabling 530 a connection between a user device and a 3GPP EPC network. In some embodiments, the method 500 may correspond to operations performed by the HRPD network 120 of FIG. 1 or the HRPD gateway 300 of FIG. 3. In certain embodiments, the method 500 can enable a connection between a user device and a 3GPP EPC network via an HRPD network.

In certain embodiments, receiving 510 a connection request with an APN may include a HSGW receiving the connection request from a user device. In some embodiments, the HSGW analyzes the connection request and identifies the APN. In certain embodiments, determining 520 a PDN gateway corresponding to the APN may include an HSGW accessing data stored internally or externally with respect to the HSGW. In some embodiments, the determining 520 may include an HSGW communicating with a network node of the HRPD network to which the HSGW corresponds, or another network.

Enabling 530 a connection between a user device and a 3GPP EPC network may include communicating with one or more network nodes of the 3GPP EPC network. The enabling 530 may include communicating with a PDN gateway of the 3GPP EPC and may also include communicating the APN, and/or data corresponding thereto, to a MME or S-GW of the 3GPP EPC. One skilled in the art will appreciate that the connection enabled may include a bearer connection or a tunnel connection, such as a GRE tunnel.

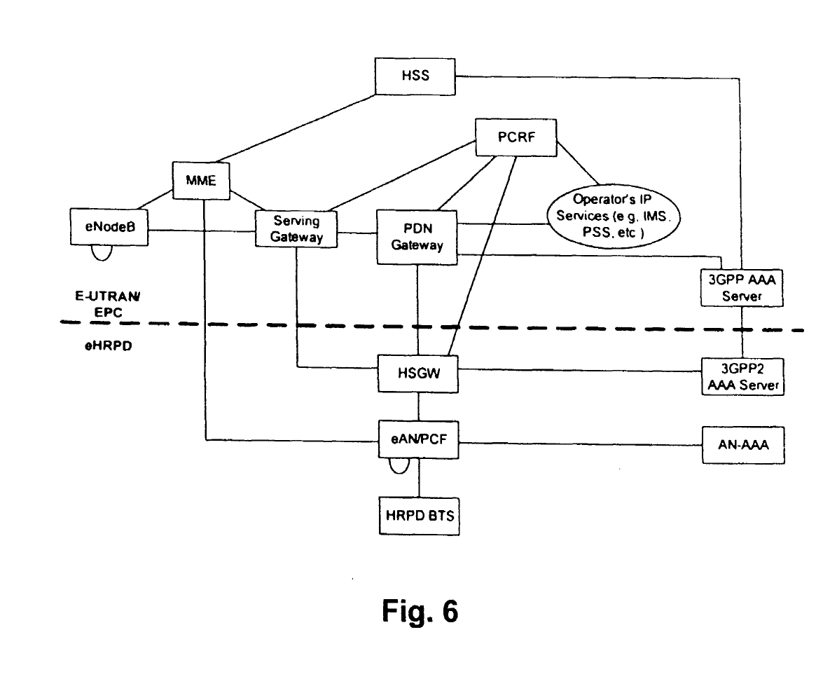

FIG. 6 is a block diagram of a system 600 in accordance with one embodiment of the present invention. The depicted system includes an E-UTRAN EPC Network and an eHRPD that may, in certain embodiments, correspond to the HRPD Network 120 and the 3GPP EPC Network 130 of FIG. 1. Similarly, the depicted HSGW, PDN Gateway, Serving Gateway, MME, may correspond to one or more features or operations described throughout this specification.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

A computer readable medium may be at least partially embodied by a transmission line, a compact disk, digital-video disk, a magnetic tape, a Bernoulli drive, a magnetic disk, holographic disk or tape, a punch card, flash memory, magnetoresistive memory, integrated circuits, or other digital processing apparatus memory device.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

1. A method, comprising:
detecting a need to establish a connection with a packet core network;
determining an access point name value that corresponds to the packet core network;
including the access point name value in a connection request message; and
communicating the connection request to a high rate packet data network to establish a connection with the packet core network.

2. The method of claim 1, wherein the detecting of the need to establish the connection is based on selected criteria, the criteria comprising one of an operator identity in a broadcast message and acknowledgment of a capacity of the high rate packet data network or the packet core network.

3. The method of claim 1, wherein the communicating comprises communicating the connection request message to a high rate packet data serving gateway of the high rate packet data network, the gateway comprising a mobile access gateway function for determining an appropriate packet data network gateway for sending a binding message.

4. The method of claim 1, wherein the connection corresponds to a packet data network gateway comprising a local mobility anchor function and corresponding to the packet core network.

5. The method of claim 1, wherein the connection comprises a Generic Routing Encapsulation (GRE) tunnel or a bearer connection.

6. The method of claim 1, wherein the detecting, the determining, the including, and the communicating are performed by a user device.

7. The method of claim 1, wherein the connection request comprises a packet data network connection request or a vendor specific network control protocol configuration request.

8. An apparatus, comprising:
a connection detection unit configured to detect a need to establish a connection with a packet core network,
an access point name determination unit configured to determine an access point name value corresponding to the packet core network;
a connection request generation unit configured to include the access point name value in a connection request message; and
a high rate packet data network interface unit configured to communicate the connection request to a high rate packet data network to establish a connection with the packet core network.

9. The apparatus of claim 8, wherein the connection detection unit is configured to detect the need to establish the connection based on selected criteria, the criteria comprising one of an operator identity in a broadcast message and acknowledgment of a capacity of the high rate packet data network or the packet core network.

10. The apparatus of claim 8, wherein the high rate packet data interface unit is configured to communicate the connection request to a high rate packet data serving gateway of the high rate packet data network.

11. The apparatus of claim 8, wherein the high rate packet data serving gateway comprises a mobile access gateway function configured to determine an appropriate packet data network gateway of the packet core network for sending a binding message.

12. The apparatus of claim 8, wherein the packet data network gateway comprises a local mobility anchor function configured to facilitate establishment of the connection.

13. The apparatus of claim 8, wherein the connection comprises a Generic Routing Encapsulation (GRE) tunnel.

14. The apparatus of claim 8, wherein apparatus comprises a user device.

15. The apparatus of claim 8, wherein the connection request comprises a packet data network connection request or a vendor specific network control protocol configuration request.

16. A method, comprising:
receiving, by a high rate packet data network gateway of a high rate packet data network, a connection request from a user device, wherein the connection request comprises an access point name value;
determining a packet data network gateway corresponding to the access point name value in the connection request; and
enabling a connection between the user device and a packet core network corresponding to the packet data network gateway.

17. The method of claim 16, wherein the determining of the packet data network gateway corresponding to the access point name value comprises using a mobile access gateway function.

18. The method of claim 16, wherein the enabling of the connection comprises sending a binding message to the packet data network gateway.

19. The method of claim 16, wherein the enabling of the connection comprises enabling a Generic Routing Encapsulation (GRE) tunnel.

20. The method of claim 16, wherein the connection request comprises a packet data network connection request or a vendor specific network control protocol configuration request.

21. An apparatus, comprising:
a connection request reception unit configured to receive, in a high rate packet data network gateway of a high rate packet data network, a connection request from a user device, wherein the connection request comprises an access point name value;
a packet data network gateway determination unit configured to determine a packet data network gateway that corresponds to the access point name value in the connection request; and
a connection enabling unit configured to enable a connection between the user device and a packet core network corresponding to the packet data network gateway.

22. The apparatus of claim 21, wherein the packet data network gateway determination unit is configured to use a mobile access gateway function.

23. The apparatus of claim 21, wherein the connection enabling unit is configured to send a binding message to the packet data network gateway.

24. The apparatus of claim 21, wherein the connection enabling unit is configured to enable a Generic Routing Encapsulation (GRE) tunnel.

25. The apparatus of claim 21, wherein the connection request comprises a packet data network connection request or a vendor specific network control protocol configuration request.

26. An apparatus, comprising:
receiving means for receiving, by a network node of a high rate packet data network, a connection request from a user device, wherein the connection request comprises an access point name value,
determining means for determining a packet data network gateway corresponding to the access point name value in the connection request; and
enabling means for enabling a connection between the user device and a packet core network corresponding to the packet data network gateway.

27. A computer program embodied on a computer-readable medium, the computer program configured to control a processor to perform operations comprising:
detecting a need to establish a connection with a packet core network;
determining an access point name value corresponding to the packet core network;
including the access point name value in a connection request message;
communicating the connection request to a high rate packet data network to establish a connection with the packet core network;
receiving, by the high rate packet data network gateway of the high rate packet data network, the connection request from a user device, wherein the connection request comprises the access point name value;
determining a packet data network gateway corresponding to the access point name value in the connection request; and
enabling a connection between the user device and the packet core network corresponding to the packet data network gateway.
